(19) United States
(12) Patent Application Publication
(10) Pub. No.: US 2014/0295382 A1
(43) Pub. Date: Oct. 2, 2014

(54) SYSTEM AND A METHOD FOR GENERATING A MEAL PLAN

(71) Applicant: Scott Ko, Glenhuntly (AU)

(72) Inventor: Scott Ko, Glenhuntly (AU)

(73) Assignee: FOOD KO UNIVERSE PTY LTD, Glenhuntly, Victoria (AU)

(21) Appl. No.: 14/001,692

(22) PCT Filed: Feb. 28, 2012
(86) PCT No.: PCT/AU2012/000190

§ 371 Date: Sep. 30, 2013

Related U.S. Application Data
(60) Provisional application No. 61/447,308, filed on Feb. 28, 2011.

(51) Int. Cl. G06F 17/30

(52) U.S. Cl. CPC G06F 17/30
USPC 434/127

(57) ABSTRACT

There is provided a system (10) for generating a meal plan for one or more persons. The system comprises: an input device (134); a recipe locator (163); an ingredient locator (165); an ingredient quantity calculator (166); a meal plan generator (168); and an output device (138).

### RELATED APPLICATION

This application claims the benefit of the priority of U.S. provisional application No. 61/447,308, the content of which as filed is incorporated by reference in its entirety.

### FIELD

The present invention relates to a system and a method for generating a meal plan, and is of particular but by no means exclusive application in generating a meal plan using parameters for a group of people.

### BACKGROUND

Many people plan their meals (such as breakfast, lunch or dinner) in advance. For some people, planning meals in advance makes purchasing groceries more straightforward since the shopper can purchase all the groceries required for a set of meals in a single shopping trip. Also, some people find it easier to stick to a particular diet (for example, a diet for losing weight, a diet for improving athletic performance etc) by planning meals in advance.

A meal plan sets out the meals the planner intends to prepare or have. Meal plans can be found on the Internet. However, such meal plans are usually manually put together by professionals in the health or food industry for only a particular group people. Accordingly, these meal plans do not cater to the specific user preferences or requirements (such as the amount of food a person plans to have in their meals, or certain types of food that a person is looking to avoid in their diet) of people that are not of that particular group.

### SUMMARY OF INVENTION

In a first aspect, the present invention provides a system for generating a meal plan for one or more persons, the system comprising:
an input device adapted to receive a plurality of input parameters;
a recipe locator adapted to receive a plurality of sets of meal parameters comprising or derived from at least one of the input parameters, to locate a plurality of recipes stored in a recipe database based on the sets of meal parameters, and to retrieve a plurality of recipe identifiers corresponding to the respective located recipes;
an ingredient locator adapted to receive the recipe identifiers, to locate a plurality of sets of ingredients stored in an ingredient database based on the recipe identifiers, and to retrieve a plurality of sets of ingredient quantities corresponding to the respective located sets of ingredients;
an ingredient quantity calculator adapted to receive the sets of ingredient quantities and at least one of the input parameters, and to calculate a plurality of sets of meal ingredient quantities based on the sets of ingredient quantities and the at least one of the input parameters;
a meal plan generator adapted to receive at least one of the group consisting of: the recipe identifiers, the sets of ingredients and the sets of meal ingredient quantities, and to generate a meal plan based on the at least one of the group so received; and
an output device adapted to output the meal plan.

Persons skilled in the art will appreciate that a meal plan relates to one or more meals (for example, breakfast, lunch or dinner). Persons skilled in the art will also appreciate that the term “recipe” refers to the instructions for preparing, cooking, or preparing and cooking one or more of the dishes of a meal (that is, a culinary recipe), and that a dish may be either a standalone dish, a main dish or a side dish.

In an embodiment, the system further comprises a meal map generator adapted to receive at least one of the input parameters received by the data input device, and to generate a meal map comprising a plurality of sets of meal parameters based on the at least one of the input parameters, each set of meal parameters comprising one or more meal parameters.

In an embodiment, each recipe is associated with a portion size parameter indicative of the portion size of a dish prepared according to the recipe.

In an embodiment, each recipe is associated with a recipe serve parameter indicative of the number of person or persons a dish prepared according to the recipe is intended to serve.

In an embodiment, at least one of the input parameters is a portion size parameter.

In an embodiment, at least one of the input parameters is a household size parameter indicative of the number of person or persons of a household.

In an embodiment, the ingredient quantity calculator is further adapted to:
receive the recipe serve parameter corresponding to each one of the recipes, the portion size parameter corresponding to each one of the recipes, the household size parameter, and the portion size parameter of the at least one of the input parameters; and
calculate each one of a set of meal ingredient quantities by (i) dividing a ingredient quantity corresponding to the meal ingredient quantity with the recipe serve parameter corresponding to a recipe and a value comprising or derived from the portion size parameter corresponding to the recipe, and (ii) multiplying the result with the household size parameter and a value comprising or derived from the portion size parameter of the at least one of the input parameters.

In an embodiment, the portion size parameter may be one of at least three values. In one example, the at least three values are: light, medium and heavy. In another example, the at least three values are: small, regular, large, and extra large.

In an embodiment, each of the recipes located by the recipe locator is associated with recipe parameters that match a respective set of meal parameters.

In an embodiment, the recipe parameters comprise at least one of the group consisting of: cuisine type, complexity, cooking time, recipe type, breakfast flag, food group, and long preparation flag.

In an embodiment, the system comprises a storage device comprising the recipe database and the ingredient database.

In an embodiment, the system comprises at least one user terminal comprising the input device and the output device; and
a server in data communication with the at least one user terminal, the recipe database, and the ingredient database, the server comprising the meal map generator, the recipe locator, the ingredient locator, the ingredient quantity calculator and the meal plan generator.

In an embodiment, the system comprises at least one user terminal comprising the input device, the meal map generator, the recipe locator, the ingredient locator, the ingredient quantity calculator, the meal plan generator, and the output device; and
a server in data communication with the at least one user terminal, the recipe database, and the ingredient database.

In an embodiment, the output device is a display device adapted to display the meal plan.

In an embodiment, the meal plan comprises a plurality of meal titles.

In an embodiment, the meal plan comprises a plurality of corresponding meal titles and sets of ingredients.

In an embodiment, each set of meal parameters comprises at least one meal parameter, each set of ingredients comprises at least one ingredient, each set of ingredient quantities comprises at least one ingredient quantity, and each set of meal ingredient quantities comprises at least one meal ingredient quantity.

In a second aspect, the present invention provides a system for generating a shopping list comprising a list of corresponding ingredients and ingredient quantities, the system comprising:
the above system for generating a meal plan for one or more people; and
a shopping list generator adapted to receive the sets of ingredients and the sets of meal ingredient quantities, and to generate a shopping list based on the sets of ingredients and the sets of meal ingredient quantities

In a third aspect, the present invention provides a method of generating a meal plan for one or more people, the method comprising:

receiving a plurality of input parameters;

locating a plurality of recipes stored in a recipe database based on a plurality of sets of meal parameters comprising or derived from at least one of the input parameters;

retrieving a plurality of recipe identifiers, each recipe identifier corresponding to a respective one of the plurality of recipes;

locating a plurality of sets of ingredients stored in an ingredient database based on the plurality of recipe identifiers;

retrieving a plurality of sets of ingredient quantities, each ingredient quantity of each set of ingredient quantities corresponding to a respective ingredient of a respective set of ingredients;

calculating a plurality of sets of meal ingredient quantities based on at least one of the input parameters and the plurality of sets of ingredient quantities;

generating a meal plan based on at least one of the group consisting of: the plurality of recipe identifiers, the plurality of sets of ingredients, and the plurality of sets of meal ingredient quantities; and

outputting the meal plan.

In an embodiment, the method further comprises generating a meal map comprising a plurality of sets of meal parameters based on at least one of the input parameters.

In an embodiment, each recipe is associated with a portion size parameter indicative of the portion size of a dish prepared according to the recipe.

In an embodiment, each recipe is associated with a recipe serve parameter indicative of the number of person or persons a dish prepared according to the recipe is intended to serve.

In an embodiment, at least one of the input parameters is a portion size parameter.

In an embodiment, at least one of the input parameters is a household size parameter indicative of the number of person or persons of a household.

In an embodiment, each one of the meal ingredient quantities is calculated by (i) dividing an ingredient quantity corresponding to the meal ingredient quantity with the recipe serve parameter corresponding to a recipe and a value comprising or derived from the portion size parameter corresponding to the recipe, and (ii) multiplying the result with the household size parameter and a value comprising or derived from the portion size parameter of the at least one of the input parameters.

In an embodiment, each portion size parameter is one of at least three values.

In an embodiment, each of the recipes corresponds to a set of meal parameters, and each of the located recipes is associated with recipe parameters that match a respective set of meal parameters.

In an embodiment, the recipe parameters comprise at least one of the group consisting of: cuisine type, complexity, cooking time, recipe type, breakfast flag, food group, and long preparation flag.

In an embodiment, the recipe database and the ingredient database are stored in the same storage device.

In an embodiment, the input parameters are received by an input device of a user terminal and the meal plan is outputted by a output device of the user terminal, and wherein the meal map is generated by a meal map generator implemented by a server connected to the recipe database and the ingredient set database, the recipes are located by a recipe locator implemented by the server, the sets of ingredients are located by an ingredient locator implemented by the server, and the sets of meal ingredient quantities are determined by an ingredient quantity calculator implemented by the server.

In an embodiment, the input parameters are received by an input device of a user terminal in data communication with the recipe database and the ingredient database, the meal plan is outputted by a output device of the user terminal, the meal map is generated by a meal map generator implemented by the user terminal, the recipes are located by a recipe locator implemented by the user terminal, the sets of ingredients are located by an ingredient locator implemented by the user terminal, and the sets of meal ingredient quantities are calculated by an ingredient quantity calculator implemented by the user terminal.

In an embodiment, the meal plan is outputted by displaying the meal plan on a display.

In an embodiment, the meal plan comprises a plurality of meal titles.

In an embodiment, the meal plan comprises a plurality of corresponding meal titles and sets of ingredients.

In an embodiment, each set of meal parameters comprises at least one meal parameter, each set of ingredients comprises at least one ingredient, each set of ingredient quantities comprises at least one ingredient quantity, and each set of meal ingredient quantities comprises at least one meal ingredient quantity.

In a fourth aspect, the present invention provides a method for generating a shopping list comprising a list of corresponding ingredients and ingredient quantities, the method comprising:
generating a meal plan for one or more people, according to the above method; and
generating a shopping list based on the sets of ingredients and the sets of meal ingredient quantities.

### BRIEF DESCRIPTION OF DRAWINGS

In order that the invention may be more clearly ascertained, embodiments will now be described, by way of example, with reference to the accompanying drawings, in which:

FIG. 1 is a schematic diagram of the physical architecture of a system for generating a meal plan, according to an embodiment of the present invention;

FIG. 2 is a schematic diagram of the functional components of the system of FIG. 1;

FIG. 3 is a flow chart of a computing method according to an embodiment of the present invention, carried out using the system of FIGS. 1 and 2;

FIG. 4 is a screenshot of an example of a meal map;

FIG. 5 is a screenshot of another example of a meal map; and

FIG. 6 is a screenshot of an example of a meal plan corresponding to the meal map of FIG. 5;

FIG. 7 is a screen mock-up of the display of a web browser interacting with the system of FIGS. 1 and 2; and

FIG. 8 is a screenshot of the display of a web browser interacting with a system for generating a meal plan according to another embodiment of the present invention

### DETAILED DESCRIPTION

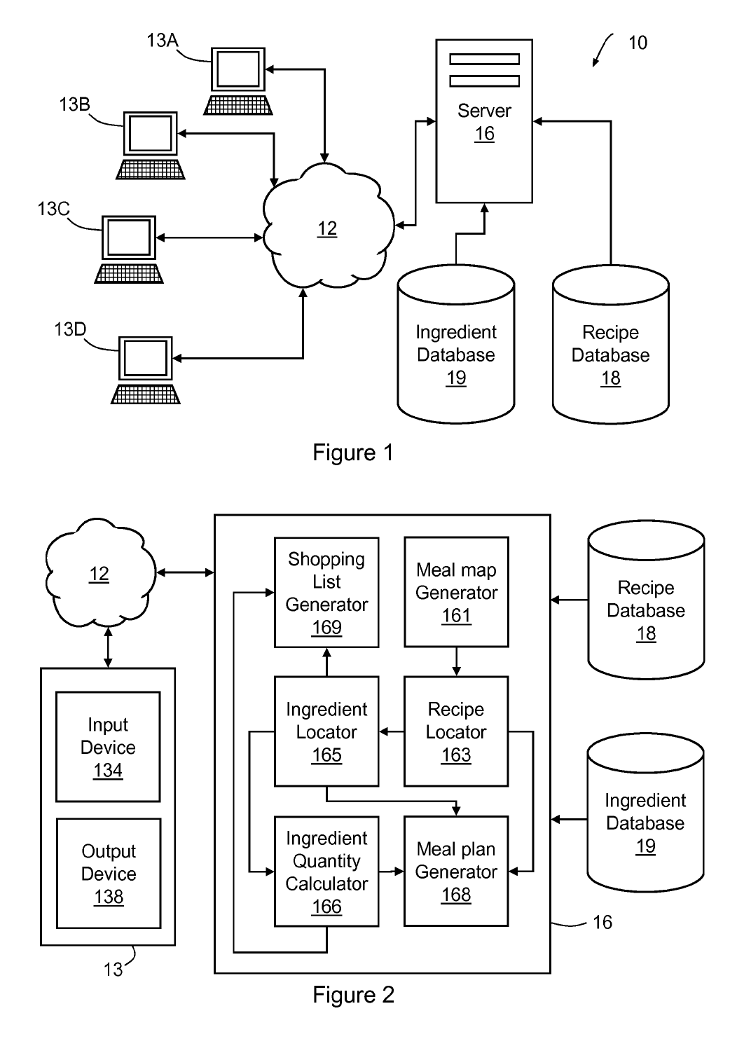

FIG. 1 is a schematic diagram of a system for generating a meal plan 10 according to an embodiment of the present invention, comprising a server 16, four user terminals 13A, 13B, 13C, 13D, a recipe database 18 and an ingredient database 19. A plurality of recipes is stored in the recipe database 18. A plurality of ingredients is stored in the ingredient database 19. A user interacts with the system 10 via a web browser running on one of the user terminals 13. Person skilled in the art will appreciate that one or more other users user may interact with the system 10 via the other one or ones of the user terminals 13.

The system 10 is adapted to receive input parameters from the users, and to, in response, generate a meal plan, or a meal plan and a shopping list. As is described in greater detail below, the input parameters indicate a user's preferences (such as the type of food or ingredient the user desires or would like to exclude).

Each of the user terminals 13 is adapted to receive one or more input parameters from a user. Each terminal 13 is also adapted to output to the user a meal plan, or a meal plan and a shopping list. Meal plans and shopping lists are generated by the server 16 based on the input parameters received by the user terminals, the recipes stored in the recipe database 18, and the ingredients stored in the ingredient database 19.

The server 16 is connected to the recipe database 18 and the ingredient database 19 via a local area network. The server 16 is adapted to retrieve data from the recipe database 18 and the ingredient database 19 via the local area network. In use, the server 16 retrieves data from either the recipe database 18 or the ingredient database 19 by making a copy of the data stored in the database. The server 16 is also adapted to modify the data stored in either the recipe database 18 or the ingredient database 19 and to add new data to either the recipe database 18 or the ingredient database 19. In this embodiment, the local area network is an Ethernet. The server 16 may in alternative embodiments be connected to the recipe database 18 and the ingredient database 19 in some other fashion. For example, in an alternative embodiment, either one or both of the databases may be connected to the server 16 via a USB connection.

The user terminals 13A, 13B, 13C, 13D are connected to the server 16 via a wide area network 12. Thus, data may be communicated between the server 16 and each of the user terminals 13A, 13B, 13C, 13D via the wide area network 12. In this embodiment, the wide area network 12 is the Internet. It is envisaged that in other embodiments the network 12 may not be a wide area network or the Internet. For example, the network may be a local area network (such as an Intranet) in an alternative embodiment.

In this embodiment, the databases 18, 19 are implemented as separate devices to the server 16. However, it is envisaged that in some embodiments, a single device (such as a computer) may be used to implement the server 16 and the two databases. Also, instead of having a separate device for each of the recipe database 18 and the ingredient database 19, a single storage device may be used to implement both the recipe database 18 and the ingredient database 19.

FIG. 2 is a schematic diagram of the functional components of the system of FIG. 1, shown with one of the user terminals 13, the server 16, the recipe database 18, the ingredient database 19, and the wide area network 12.

The user terminal 13 comprises an input device 134, and an output device 138.

The input device 134 is adapted to receive input parameters from a user for generating the meal plan. Examples of input parameters include one or more of the following:
Cuisine type—To indicate the preferred type or types of cuisine. For example, Cantonese, Chinese (which includes Cantonese), Italian, Asian (which includes Cantonese and Chinese), European (which includes Italian) etc.
Food group—To indicate the preferred type or types of foods (for example, beef, fish, chicken, vegetables etc).
Food exceptions—To indicate the ingredient or ingredients that the user wishes to exclude from a meal (for example, ingredient or ingredients that the user is allergic to).
Attributes—To indicate specific recipe preferences such as “high in fibre” etc.
Portion size—To indicate the portion size of a meal.
Household size—To indicate the number of people in a household.
Cooking time—To indicate the length of time to cook a meal.
Complexity—To indicate the difficulty involved in preparing and cooking a meal.
Preparation duration—To indicate the length of time for preparing the ingredients for cooking a meal.
Skill level—To indicate the level of skill required to prepare a meal.
Cost level—To indicate the amount of cost associated with preparing the meal.

In this embodiment, the input parameters include: cuisine type, food group, cooking time, preparation duration, portion size and household size. However, it is envisaged that there may be an alternative or additional input parameter or parameters in an alternative embodiment. In use, a list of options for each input parameter is outputted by the output device 138 to the user, and the input device 134 receives an input parameter when the user selects one or more of the options. Persons skilled in the art will appreciate that the options may be presented to the user in different ways. For example, the options may be displayed on a display in the form of a drop-down list. Alternatively, the options may be displayed on a display in the form of a checkbox.

The output device 138 is adapted to output a meal plan, or a meal plan and a shopping list to the user. In use, the output device 138 outputs the meal plan, the shopping list, or the meal plan and the shopping list to the user in response to the input device 134 receiving one or more input parameters from the user.

In this embodiment, the input device 134 is a mouse and the output device 138 is a computer monitor display. It is envisaged that in an alternative embodiment, the input device 134 may be some other user input device. For example, the input device 134 may alternatively be a keyboard. Similarly, the output device 138 may in an alternative embodiment not be a computer monitor display. For example, the output device 138 may alternatively be a printer. It is also envisaged that in yet another embodiment, the input device 134 and the output device 138 may be the same device (such as a touch screen) or may not be user devices but computer input/output devices (such as network cards or wireless transceivers) instead of user input/output devices.

The server 16 is arranged to implement a number of modules to generate a meal plan. Persons skilled in the art will appreciate that the modules are typically implemented by the processor of the server 16 executing program code and data stored in the memory of the server 16 but that one or more of the modules could be implemented in an alternative manner, for example, as a dedicated circuit.

One of the modules implemented by the server 16 is a meal map generator 161 adapted to generate a meal map comprising a plurality of sets of meal parameters. In this embodiment, the meal parameters of each set of meal parameters include: cuisine type, food group, cooking time, and long preparation flag. In use, the meal map generator 161 receives input parameters received by the input device 134, and generates the sets of meal parameters based the input parameters. In this embodiment, each set of meal parameters is generated by determining meal parameters corresponding to the input parameters. For example, if the cuisine type input by a user is Asian (that is, the cuisine type of the input parameters), the cuisine type generated by the meal map generator (that is, the cuisine type of the meal parameters) will also be Asian. Alternatively, if more than one option is input by a user for a cuisine type (for example, if the user inputs both Asian and European), the cuisine type generated by the meal map generator will be selected randomly or using a predetermined algorithm from one of Asian or European. In another example, the meal map generator sets the long preparation flag to “Yes” if the preparation duration input by the user is equal or above a threshold value, or “No” if the preparation duration input by the user is below the threshold value.

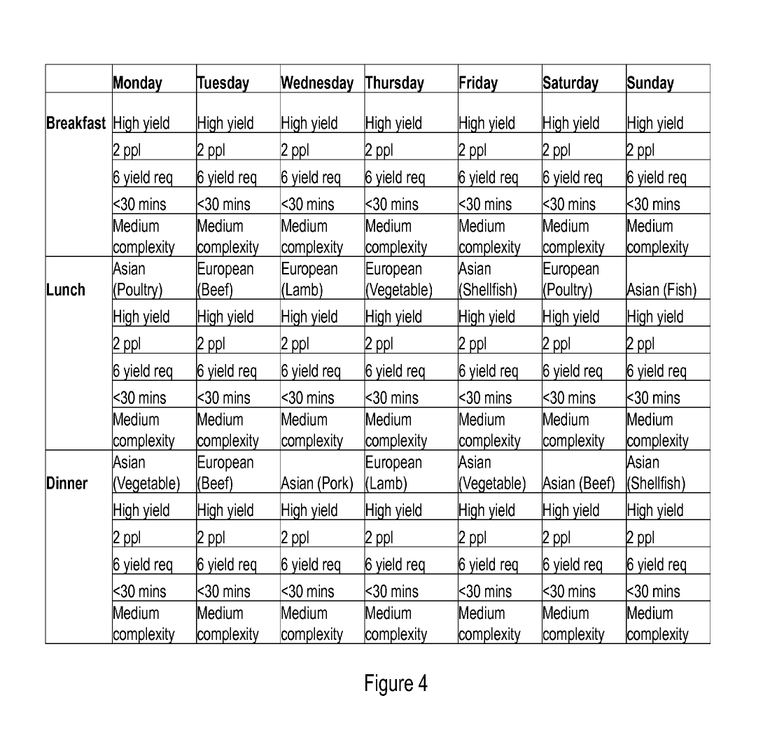

FIG. 4 is a screenshot of an example of a 7-day meal map showing the sets of meal parameters for breakfast, lunch and dinner for the period of a week. As illustrated in this figure, each set of meal parameters corresponds to an entry of a meal plan (that is, a meal in the meal plan).

A recipe locator 163 is used to locate a plurality of recipes stored in the recipe database 18 based on the sets of meal parameters, and to retrieve a plurality of recipe identifiers corresponding to a respective one of the located recipes. That is, the recipe locator 163 is adapted to receive the sets of meal parameters generated by the meal map generator 161, to locate the recipes stored in the recipe database 18, and to retrieve a plurality of recipe identifiers stored in the recipe database 18, each recipe identifier corresponding to a respective one of the recipes.

In this embodiment, the recipes are stored in separate files and the recipe identifier of each recipe is the name of a respective file storing the recipe. Each of these files comprises one or more recipe parameters. Thus, each of the recipes stored in the recipe database 18 is associated with one or more recipe parameters. These recipe parameters comprise at least one of the group consisting of: recipe serve, portion size, cuisine type, complexity, cooking time, recipe type, breakfast flag, and food group, and long preparation flag. A more detailed description of how the recipes are stored in the recipe database 18 is provided in Table 1 below.

In use, the recipe locator 163 receives the sets of meal parameters generated by the meal map generator 161, and locates recipes by locating recipes that are associated with recipe parameters that match a respective set of meal parameters. That is, for each set of meal parameters, the recipe locator 163 locates one or more recipes that are associated with recipe parameters that match the set of meal parameters. For example, if the meal parameters of a particular meal specify an “Asian” cuisine type, the recipe locator 163 will locate recipes that have a cuisine type parameter of either “Asian”, “Chinese”, “Cantonese” etc. In this embodiment, the recipe locator 163 locates the recipes for each set of meal parameters by first querying the recipe database 18 for recipes that are associated with recipe parameters that match the meal recipe parameters (that is, recipes that are of the same cuisine type, food group, cooking time etc as those specified by the meal parameters). If more than one recipe is located for a set of meal parameters, the recipe locator 163 then randomly selects one of the recipes so located. Also, if a recipe cannot be located for a set of meal parameters, the system may be additionally configured to prompt the user to modify the input parameters to broaden the scope of potentially acceptable recipes. It is envisaged that in some embodiments, the recipe locator 163 is also adapted to select the recipes such that the recipe selected for a particular meal is not repeated the next day. The generated meal map is then stored in memory for subsequent retrieval or use.

An ingredient locator 165 implemented by the server 16 is adapted to locate a plurality of ingredients stored in the ingredient database 19 based on the recipe identifiers retrieved by the recipe locator 163. In the ingredient database 19, separate files are used to store the ingredients of the recipes stored in the recipe database 18, and the name of each file storing the ingredients of a recipe is the recipe identifier corresponding to the recipe. Thus, each recipe identifier is associated with a set of one or more ingredients. In addition, each file comprises not only the ingredients for a recipe but also an ingredient quantity parameter indicating the numerical quantity of each of the ingredients required for the recipe and an ingredient unit parameter indicating the unit of measure corresponding to the ingredient quantity parameter. Thus, each ingredient of each set of one or more ingredients stored in the ingredient database 19 is associated with an ingredient quantity parameter and an ingredient unit parameter. A more detailed description of how the ingredients are stored in the ingredient database 19 is provided in Table 2 below.

In use, the ingredient locator 165 first receives the recipe identifiers. Then the ingredient locator 165 locates the plurality of sets of ingredients stored in the ingredient database 19 associated with the respective recipe identifiers based on the recipe identifiers, before retrieving the plurality of sets of ingredient quantities corresponding to the respective sets of ingredients.

An ingredient quantity calculator 166 is adapted to receive the sets of ingredient quantities retrieved by the ingredient locator 165 and the portion size parameter and the household size parameter received by the input device 161, and to calculate a plurality of sets of meal ingredient quantities based on the sets of ingredient quantities and the at least one of the portion size parameter and the household size parameter. As indicated above, the portion size parameter is indicative of a user's preferred portion size for a dish. The household size parameter is indicative of the number of person or persons of a household. Also, each of the recipes stored in the recipe database 18 is associated with a portion size parameter indicative of the portion size of a dish prepared according to the recipe, and a recipe serve parameter indicative of the number of person or persons a dish prepared according to the recipe is intended to serve. In this embodiment, each portion size parameter is one of three values: small yield, medium yield or high yield (also referred to as: light, medium or heavy). Persons skilled in the art will appreciate that the portion size parameter may in other embodiments be one of more or less than three values. For example, in an alternative embodiment, each portion size parameter may be one of four values such as one of four values: small, regular, large, or extra large.

In use, the ingredient quantity calculator 166 receives the recipe serve parameter corresponding to each one of the recipes, the portion size parameter corresponding to each one of the recipes, the household size parameter received by the input device 134, and the portion size parameter received by the input device 134. Then, the ingredient quantity calculator 166 calculates each meal ingredient quantity by:

(i) dividing an ingredient quantity corresponding to the meal ingredient quantity with (a) the recipe serve parameter corresponding to a recipe—to determine the quantity for 1 person—and (b) a value comprising or derived from the portion size parameter corresponding to the recipe—to determine the quantity for 1 person eating a “light” portion size—and then
(ii) multiplying the result from (i) with (c) the household size parameter—to determine the quantity for the household size—and (d) a value comprising or derived from the portion size parameter received by the input device 134 (that is, the portion size parameter received as part of the input parameters).

In this embodiment, the value comprising or derived from the portion size parameter is one of three values: 1, 2 and 3. Thus, in this embodiment, a “light” portion size is equivalent to half of a “medium” portion size and a third of a “heavy” portion size. In an alternative embodiment, the ingredient calculator may calculate each ingredient quantity using only one or some of the parameters (a), (b), (c) and (d), such that only one or some of these parameters are taken into account in the calculation.

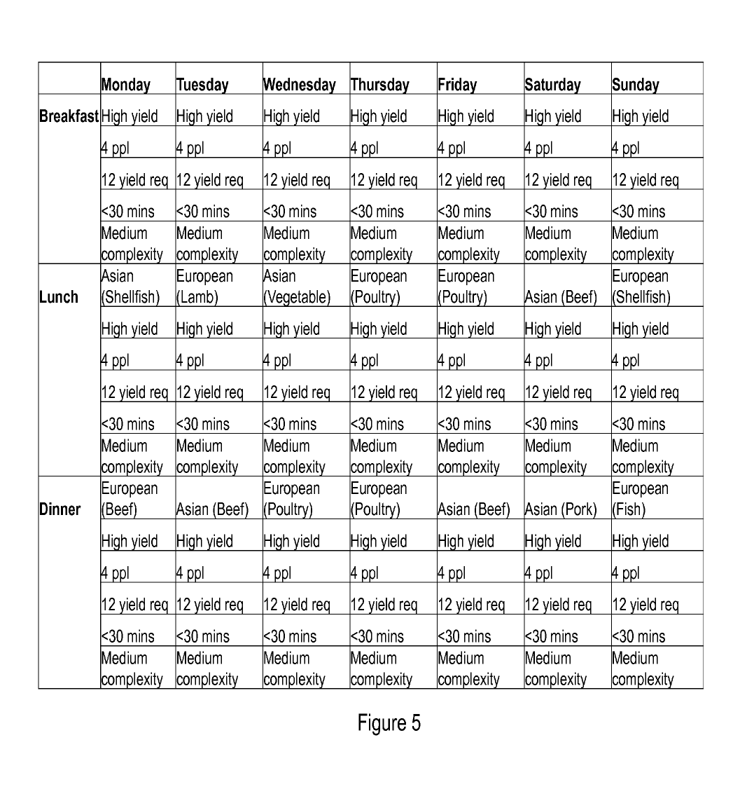

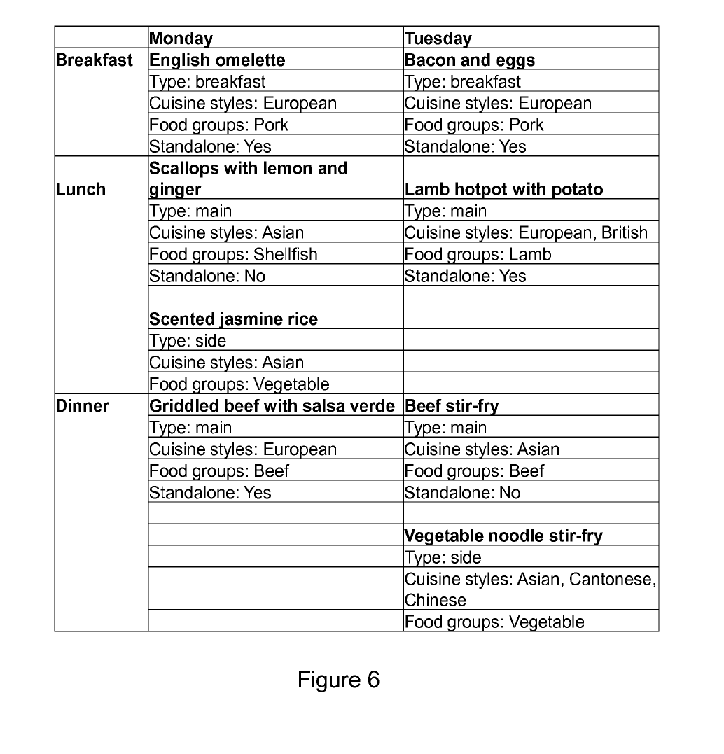

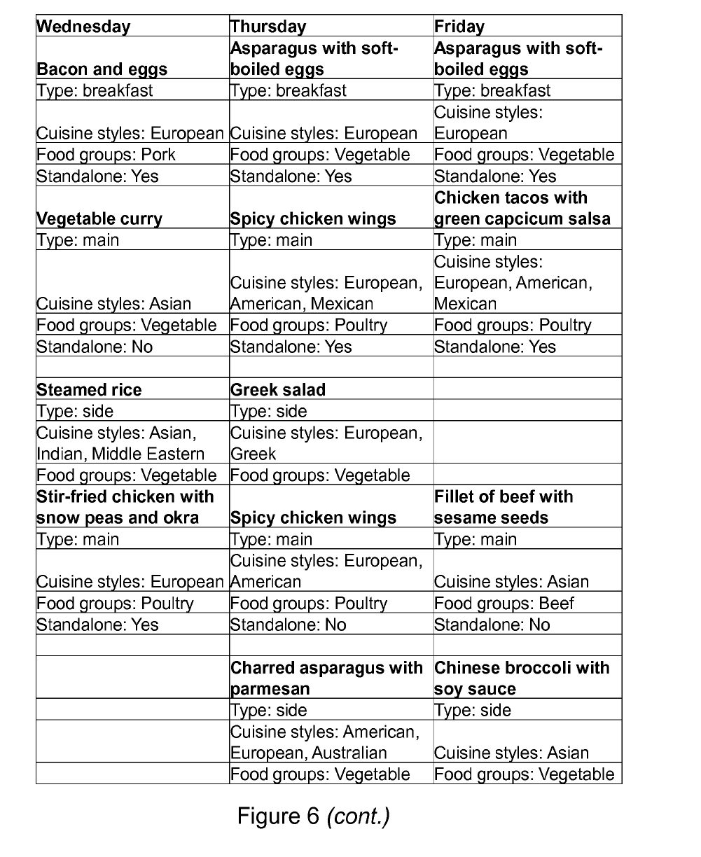

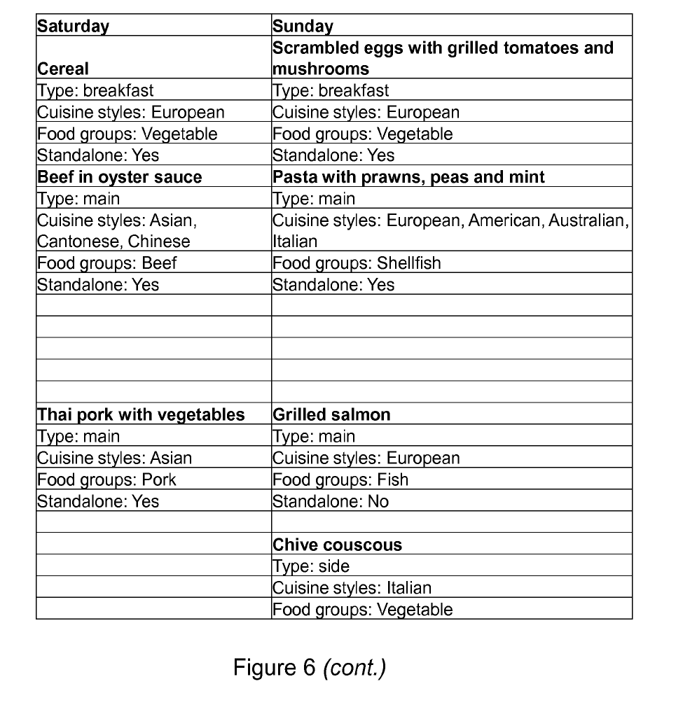

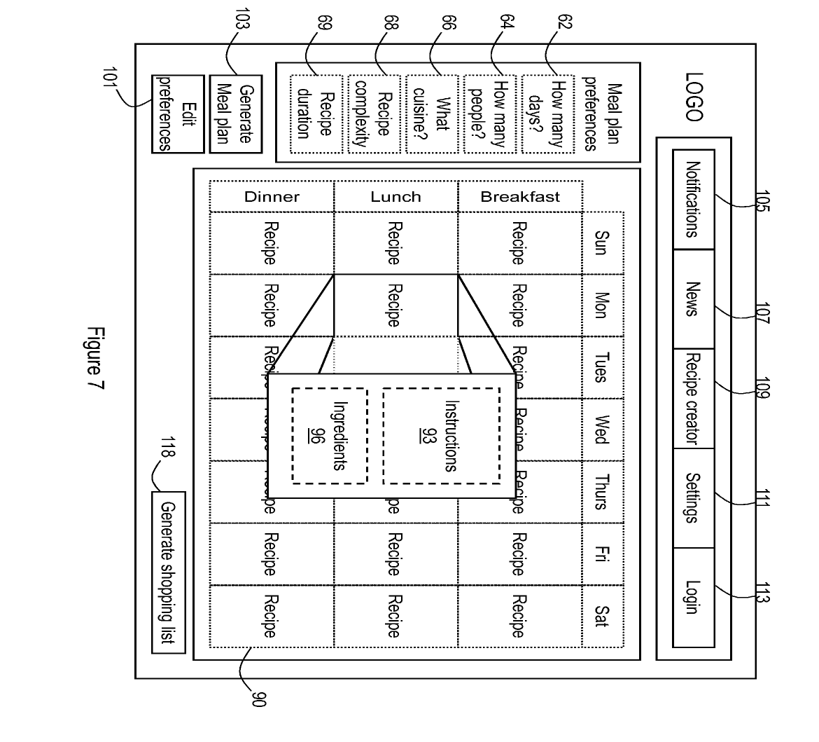

In the system 10, the server 16 also implements a meal plan generator 168. The meal plan generator 168 is adapted to receive at least one of the group comprising: the recipe identifiers retrieved by the recipe locator 163, the sets of ingredients retrieved by the ingredient locator 165, and the sets of meal ingredient quantities calculated by the ingredient quantity calculator 166, and to generate a meal plan based on the at least one of the group. FIG. 6 is a screenshot of an example of a meal plan, corresponding to the meal map of FIG. 5. Depending on the embodiment, the meal plan generator 168 can generate meal plans ranging from relatively simple meal plans comprising only a plurality of recipe titles by locating and retrieving the recipes titles associated with the recipe identifiers retrieved by the recipe locator 163, to more complex meal plans comprising the instructions and the ingredients for each recipe (including the amount required for each ingredient) by locating and retrieving the instructions and the sets of ingredients associated with the recipe identifiers and the meal ingredient quantities calculated by the ingredient quantity calculator 166.

Finally, the server 16 also implements a shopping list generator 169. In use, the shopping list generator 169 receives the sets of ingredients located by the ingredient locator 165 and the sets of meal ingredient quantities calculated by the ingredient quantity calculator 166, and generates a shopping list that lists the sets of ingredients and the sets of meal ingredient quantities.

It is envisaged that in some embodiments, the system is adapted to receive not only input parameters indicating a user's food preferences but also food or ingredients that the user would like to exclude (“Food Exceptions”), and the system is adapted to locate only recipes which do not include the food or ingredients that the user would like to exclude. For example, in one embodiment, the system comprises a module adapted to receive the recipe identifiers from the recipe locator 161 and the sets of ingredients located by the ingredient locator 163, and to filter the recipes located by the recipe locator 163 that uses an ingredient that matches one or more of the Food Exceptions.

Also, it is envisaged that the system may additionally associate the recipes stored in the recipe database 18 with specific recipe attributes. This association may be through an additional attribute field in the recipe database 18 or in a separate attribute database. For example, in an alternative embodiment, the system may additionally include an attribute database comprising one or more of the recipe identifiers, each recipe identifier of the attribute database associated with one or more attributes including “high in fibre”, “quick to cook”, “low skill level”, “easy on wallet” etc.

In this embodiment, the system involves an ingredient database 19 for locating the ingredients required for each located recipe. It is envisaged that the system may additionally or alternatively involves databases for locating other information relevant to each recipe. For example, in an alternative embodiment, the system may be additionally arranged to locate the cooking utensils required for preparing or cooking the recipes stored in the recipe database 18 from an equipment database.

Also, it is envisaged that ingredient database 19 may additionally include one or more substitute ingredients for each of the ingredients stored in the ingredient database 19, and that the server 16 may be additionally be configured to substitute an ingredient of a recipe with another ingredient to satisfy a user's preferences. For example, in an alternative embodiment, the ingredient database 19 may list the ingredient “white sugar” and the ingredient “artificial sweetener” as alternatives for the ingredient “brown sugar”. In such an embodiment, the server 16 may be configured to substitute an ingredient for another ingredient for a located recipe in certain cases (for example, in the case when the server 16 is not able to locate a recipe that satisfies the input parameters). An example of such an implementation in provided below in the section entitled “Table 2: Form in which the ingredients are stored in the ingredient database 19” (see the ingredient characteristic database).

It is envisaged that the system may additionally optimize the generated meal plan to take into account perishable ingredients. For example, in an alternative embodiment, the system may be configured to additionally rearrange a generated meal plan so that recipes having more perishable ingredients are scheduled earlier in the week before Wednesday. Alternatively or additionally, the system may be configured to additionally rearrange a generated meal plan so that recipes having similar perishable ingredients are arranged in consecutive days.

It is envisaged that in an alternative embodiment, the portion size parameter received by the input device 134 may be used not only to determine the meal ingredient quantities but also to locate the recipes stored in the recipe database. For example, in one embodiment, the recipes stored in the recipe database 18 may be categorized as one of three values—Standalone recipes, Main recipes or Side recipes—and the recipe locator 163 may locate only standalone recipes if the portion size parameter received by the input device 134 is small.

It is envisaged that alternative embodiments of the system 10 may comprise more or less than four user terminals. In particular, the system may in an alternative embodiment comprise only one user terminal.

It is envisaged that the modules may not all be comprised in the server 16 and that one or more of the modules may be implemented by each of the user terminals 13. For example, in an alternative embodiment, the meal map generator, the recipe locator, the ingredient locator, the ingredient quantity calculator, and the meal plan generator may be implemented by each of the user terminals and the server is used only as a gateway for communicating with the recipe database and the ingredient database.

It is also envisaged that the system may be implemented in a single device. For example, in an alternative embodiment, the modules of the server 16 may be implemented by a computer having the input device, the output device, and memory comprising the recipe database and the ingredient database.

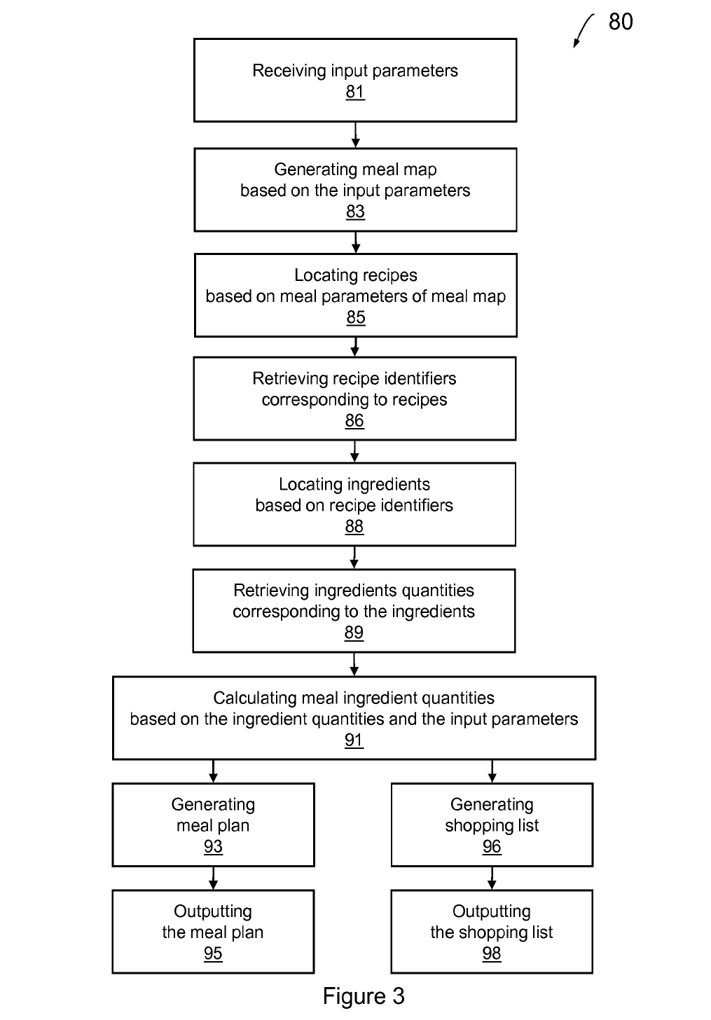

FIG. 3 is a flow chart 80 of the operation of the system of FIGS. 1 and 2.

At step 81, input parameters from a user (that is, cuisine type, food group, cooking time, preparation time, portion size, and household size) are received by the input device 134 of one of the user terminals 13. Subsequently, the input parameters are communicated from the user terminal 13 to the server 16 via the network 12.

At step 83, the meal map generator 161 receives the input parameters received by the input device 134, and generates based on the input parameters a meal map comprising a plurality of sets of meal parameters, each set of meal parameters corresponding to a meal of a meal plan. As indicated above, the meal parameters can be based on only one, some or all of the input parameters.

At step 85, the recipe locator 163 receives the meal parameters of the meal map, and locates a plurality of recipes stored in the recipe database 18 based on the meal parameters. As indicated above, the recipe locator 163 locates the recipes based on the meal parameters by locating, for each set of meal parameters, a recipe or recipes that are associated with recipe parameters that match the set of meal parameters.

At step 86, the recipe locator 163 retrieves a plurality of recipe identifiers, each corresponding to a respective one of the located recipes.

At step 88, the ingredient locator 165 receives the recipe identifiers, and locates a plurality of sets of ingredients, each set of ingredients being located based on a respective one of the recipe identifiers.

At step 89, the ingredient locator 165 retrieves a plurality of sets of ingredient quantities corresponding to the respective located sets of ingredients.

At step 91, the ingredient quantity calculator 166 receives the sets of ingredient quantities retrieved by the ingredient locator 165 and the portion size parameter and the household size parameter received by the input device 134, and calculates a plurality of sets of meal ingredient quantities. Thus, the meal ingredient quantities are customized according to the portion size parameter and the household size parameter received by the input device 134.

At step 93, a meal plan comprising recipe instructions and recipe ingredients and quantities is generated based on the recipe identifiers located by the recipe locator 163, the ingredients located by the ingredient locator 165 and the meal ingredient quantities calculated by the ingredient quantity calculator 166.

This meal plan is then communicated from the server 16 to the user terminal 13 via the network 12, and outputted by the output device 138 of the user terminal 13 at step 95.

As indicated above, in addition to or as an alternative to generating and/or outputting the meal plan, a shopping list can be generated by the system. At step 96, the shopping list generator 169 generates a shopping list (listing the ingredients used in all the recipes located for the meal plan, and the total quantity required for each ingredient) based on the sets of ingredients located by the ingredient locator 165 and the meal ingredient quantities calculated by the ingredient quantity calculator 166.

Subsequently, at step 98, this shopping list is communicated from the server 16 to the user terminal 13, and then outputted by the output device 138 of the user terminal 13.

Further aspects of the method will be apparent from the above description of the system. It will be appreciated that at least part of the method will be implemented digitally by a processor. Persons skilled in the art will also appreciate that the method could be embodied in program code. The program code could be supplied in a number of ways, for example on a tangible computer readable storage medium, such as a disc or a memory or as a data signal. Persons skilled in the art will appreciate that program code provides a series of instructions executable by the processor.

FIG. 7 is a screen mock-up of the display of a web browser interacting with the system of FIGS. 1 and 2.

In FIG. 7, input parameters are received when a user inputs into fields 62, 64, 66, 68, 69. In this embodiment, the fields 64, 66, 68, 69 correspond respectively to the input parameters: household size, cuisine type, complexity, and cooking duration. Other input parameters can be inputted into the system when the user clicks on the button “Edit preferences” 101. It is envisaged that the system is adapted to default to a predetermined value when an input parameter is not received (that is, when a user does not input an input parameter).

The system generates a meal plan when the user clicks on the button “Generate Meal Plan” 103. As discussed above, to generate the meal plan, the system first generates a meal map comprising a plurality of sets of meal parameters. In this embodiment, the meal parameters of each set of meal parameters are either the same as the input parameters (as in the case of portion size, household size etc) or randomly selected from the list of options selected by the user. For example, if the user selects “Beef”, “Fish” and “Pork” for Food Group, the meal map generator 161 will randomly selects one of “Beef”, “Fish” and “Pork” as one of the meal parameters for a meal. It is envisaged that, where possible, different meal parameters are generated for consecutive meals of the same type. For example, if the user selects “Beef”, “Fish” and “Pork” for Food Group, the meal map generator 161 will not select “Beef” as a meal parameter for dinner on two consecutive days.

Below is an example of a set of meal parameters:
Household size: 4 people
Cuisine type: European
Complexity: Medium complexity
Cooking duration: <30 minutes

In this embodiment, the instructions for preparing a recipe 93 and the ingredients required for the recipe 96 (that is, the ingredients themselves and the quantity required for each ingredient) are displayed for a respective entry of the meal plan.

A shopping list is generated when the user clicks on the button “Generate shopping list” 118. It is envisaged that the shopping list generated by the system collates the ingredients of the recipes of the meal plan such that the shopping list lists only the total quantity required for each ingredient.

In this embodiment, a user can also register an account with the system and save the input parameters (that is, their food preferences) for future use. A “Login” button 113 is provided to allow the user to login to their account (for example, to allow the user to input a username and password).

A “Settings” button 111 is provided to allow the user to change the manner in which the meal plan is displayed or outputted. For example, in an alternative embodiment, only a meal title (or meal name) may be displayed in each entry (that is, for each meal of the meal plan) and the meal title may be used as a web-link to a new page displaying the instructions for preparing the recipe and the list of ingredients required for the recipe. It is envisaged that the system may be also configured to output the meal plan or the shopping list to the user in a manner other than displaying on a web browser. For example, it is envisaged that the system may also be able to email the meal plan to a user.

A “Recipe Finder” button (not shown) is provided to allow a user to locate a particular recipe. This allows the user to find one or more recipes in the recipe database 18 that uses a particular set of ingredients (or does not use one or more particular ingredients).

A “Notifications” field 105 is provided to inform or alert the user when a meal plan has been generated. A “Recipe creator” button 109 is provided to allow the user to create a recipe and to save the recipe in the recipe database 18. It is envisaged that the ingredient database 19 may be updated when a new recipe is created. A “News” button 107 is also provided to inform users of newly created recipes.

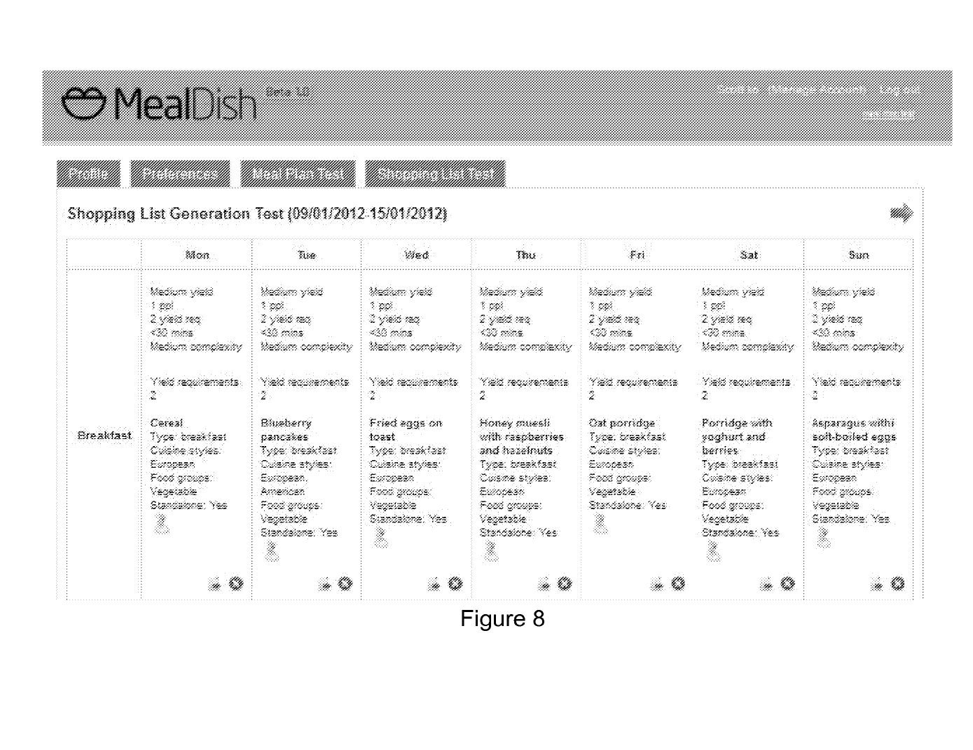

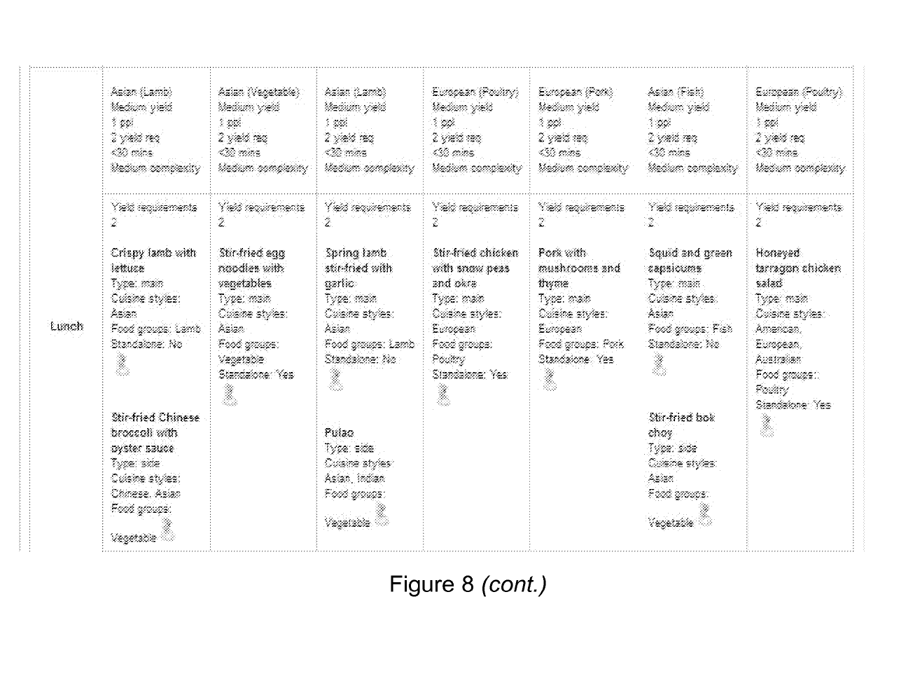

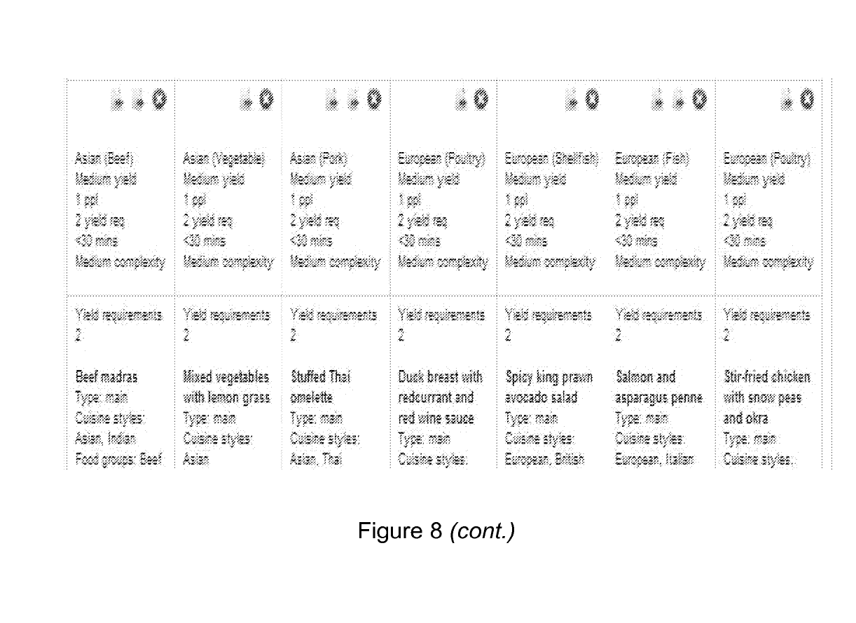

FIG. 8 is a screenshot of the display of a web browser interacting with a system for generating a meal plan according to another embodiment of the present invention.

The screenshot illustrates a shopping list generated based on a meal plan generated for the period 9 Jan. 2012 to 15 Jan. 2012. The meal plan comprises the recipes located by the system. For example, the meal plan indicates that the located recipe for Wednesday lunch is spring lamb stir-fried with garlic and pulao. The screenshot also illustrates the recipe parameters associated with the recipe. For example, the screenshot indicates that spring lamb stir-fried with garlic is a main dish, an Asian style dish, is of the lamb food group and is not a stand alone dish. Also, the screenshot illustrates the meal parameters used to derive the recipes. For example, the screenshot illustrates that the meal parameters used to derive spring lamb stir-fried with garlic are Asian (Cuisine Type or Description), Lamb (Food group), Medium yield (Portion size), 1 ppl (Recipe serve), 2 yield req (Yield corresponding to Portion size), <30 mins (Cooking time), and Medium complexity (Complexity or Skill level).

TABLE 1
Form in which the recipes are stored in the recipe database 18
As indicated above, the recipe database 18 is adapted to store a
large number of recipes. In the recipe database, there is stored
the name of the recipe and the instructions for preparing the
dish or dishes according to the recipe. In addition, each recipe
is associated with a recipe identifier (Recipe ID) and one or
more recipe parameters, as indicated below:

| | Field | |
|---|---|---|
| Field | Type | Description |
| Recipe | Numer- | Unique identifier for the recipe |
| identifier | ical | |
| (Recipe ID) | | |
| Title | Text | Recipe title or name |
| Descrip- | Text | Description of the recipe |
| tion | | |
| Instructions | Text | Preparation-related instructions for the recipe - |
| (Preparation) | | for example, chop ingredient x, slice ingredient y, |
| | | wash ingredient z, preheat oven to w° C. |
| Instructions | Text | Cooking-related instructions for the recipe. It is |
| (Cooking) | | envisaged that the majority of the instructions for |
| | | the recipe are in this field. |
| Instructions | Text | Serving-specific information for the recipe - |
| (Serving) | | for example, plate individual items, garnish with |
| | | ingredient x, season with ingredient y. |
| Recipe | Numer- | The number of people a recipe is intended to |
| Serve | ical | serve. This field is used to calculate the meal |
| parameter | | ingredient quantity to scale the recipe for more |
| | | or less people. |
| Portion | Text | The portion size for each person. For example, |
| size | | the portion size for each person could be |
| parameter | | considered as Medium. This field can be one |
| | | of the following categories: |
| | | Light (0-150 grams) - Corresponds |
| | | to a Yield Figure of 1 |
| | | Medium (150-300 grams) - Corresponds |
| | | to a Yield Figure of 2 |
| | | Heavy (300 grams or above) - Corresponds |
| | | to a Yield Figure of 3 |
| Complexity | Text | The complexity of the recipe. Complexity is |
| parameter | | measured by the number of times a user has to |
| | | attend to a recipe during when cooking the dish. |
| | | This field can be one of the following categories: |
| | | Low (if the recipe involves the cooking of all |
| | | ingredients in quick succession in a single |
| | | pan or pot) |
| | | Medium (if the recipe requires the use of |
| | | multiple pans or requires the setting aside of |
| | | cooked ingredients) |
| | | High (if the recipe requires constant monitoring |
| | | or attention by the End User or involves complex |
| | | techniques not commonly achievable in a home |
| | | kitchen) |
| Cooking | Numer- | The amount of time required to cook the dish |
| Time | ical | according to the recipe. This field can be one |
| parameter | | of the following: |
| | | 0-15 minutes |
| | | 15-30 minutes |
| | | 30-45 minutes |
| | | 45-60 minutes |
| | | 60-90 minutes |
| | | 90+ minutes |
| Preparation | Numer- | The amount of time required to prepare the |
| Time | ical | ingredients. For example, the amount of time |
| parameter | | required to wash, peel and chop the ingredients |
| | | required for the recipe. |
| Long | Bool- | Yes/No flag that indicates whether a recipe |
| Preparation | ean | requires preparation of ingredients (for |
| Flag | | example, marinating) a significant amount of |
| parameter | | time (currently set at 4 hours) before the |
| | | cooking of the dish. |
| Recipe | Text | This field can be one of the following: |
| Type | | Standalone Main - a main recipe where no |
| parameter | | side recipes are required in support. For example, |
| | | a recipe for a meat and vegetable dish. |
| | | Main - a main recipe where a side recipe is |
| | | required in support. For example, a recipe for a |
| | | purely meat/fish dish |
| | | Side - a recipe that supports a Main dish. |
| | | Side dishes cannot be served on their own |
| | | Each meal generated in the Meal Plan must |
| | | contain at least one Standalone Main or |
| | | Main recipe. |
| Breakfast | Bool- | Yes/No flag that indicates whether a recipe |
| Flag | ean | is a Breakfast recipe. |
| parameter | | |
| Cuisine | Text | The cuisine type of a recipe as described by |
| Type | | its region. For example, Asian, European etc. |
| parameter | | |
| Food | Text | This field captures the major Food Groups |
| Group | | represented in a recipe based on its ingredients. |
| parameter | | This field can be one or more of the following: |
| | | Beef |
| | | Pork |
| | | Poultry |
| | | Lamb |
| | | Fish |
| | | Shellfish |
| | | Vegetable |
| Featured | Bool- | Indicates whether or not the recipe is |
| Flag | ean | one that is to be promoted by the system. |
| parameter | | |
| Cost | Text | A cost estimate of the dish |
| parameter | | |
| Recipe | Numer- | Name of a person who came up with the dish |
| Creator | ical | |
| parameter | | |
| Likes | Numer- | This is a counter recording the number of |
| Count | ical | times the recipe has been “liked” |
| parameter | | or “recommended” by users. |
| Image | Bit- | An image associated with the recipe |
| | stream | |

It is envisaged that, in an alternative embodiment, one (or more) of the fields may be implemented such that the field is of a different type to the one of Table 1. For example, in an alternative embodiment, the “Food Group parameter” field may be a numerical value corresponding to a particular food group rather than in the form of text.

Also, it is envisaged that, in an alternative embodiment, there may be additional fields to the ones of Table 1, and/or one or more of the fields of Table 1 may not be implemented. For example, in an alternative embodiment, there may be not “Recipe Type parameter” field, but there are (i) a Boolean “Side Dish Flag parameter” field that indicates whether or not a recipe is a side dish (as opposed to a main dish) and (i) a numerical “Side Dish parameter” field that specifies a side dish recipe which accompanies a main dish recipe.

TABLE 2
Form in which the ingredients are stored in the ingredient database 19
As indicated above, a plurality of ingredients are stored in
the ingredient database 19. In the ingredient database 19,
ingredients are associated with recipe IDs. Each recipe ID
is also associated with one or more of the following fields:

| | Field | |
|---|---|---|
| Field | Type | Description |
| Recipe | Numer- | The identifier for each recipe; used to link |
| ID | ical | multiple ingredients to a recipe. |
| Ingre- | Text | An individual ingredient required for a recipe. |
| dient | | |
| Quantity | Numer- | The numerical quantity of the ingredient. |
| | ical | |
| Unit | Text | The unit of measure accompanying the quantity. |
| | | There can be multiple units of measure for |
| | | unique ingredients (ie, an ingredient can be |
| | | measured in tablespoons/teaspoons/cups/etc) |

As indicated above, each recipe identifier (Recipe ID) of the ingredient database 19 is associated with one or more ingredients. Thus, for an ingredient that is used in multiple recipes, there may be multiple entries of the ingredient. To reduce such duplication, it is envisaged that the ingredient database 19 may be implemented using two separate databases. For example, in an alternative embodiment, the ingredient database 19 may comprise an ingredient characteristic database and an ingredient quantity database. In the ingredient quantity database, separate files would be used to store ingredient identifiers corresponding to the ingredients of the recipes stored in the recipe database 18. The name of each file storing the ingredients of a recipe would correspond to the recipe identifier corresponding to the recipe. Each file would also be used to store a numerical Quantity field for each one of the ingredients of the recipe. This Quantity field would be the same as the one currently used in the ingredient database (see Table 2 below); that is, the field would be for specifying the base quantity of the ingredient needed for the recipe. The ingredient characteristic database would then include fields relating to ingredients that are not specific to any recipe.

In use, after recipes are located by the recipe locator 163, the system would adjust the quantity of each ingredient of each recipe (that is, the ingredient quantity corresponding to the ingredient) based on a corresponding Quantity field for the ingredient stored in the ingredient quantity database before the ingredient quantity calculator 166 calculates a meal ingredient quantity for the ingredient based on the adjusted ingredient quantity and the input parameters received from the user.

The tables below set out an example of an ingredient characteristic database and an example of an ingredient quantity database.

### Ingredient Quantity Database:

| Field | Field Type | Description |
|---|---|---|
| Recipe | Numer- | The identifier for each recipe; used to link a |
| ID | ical | recipe of the recipe database with an ingredient |
| | | identifier of the ingredient quantity database. |
| Ingredi- | Numer- | The identifier for each ingredient; used to link |
| ent ID | ical | an ingredient identifier of the ingredient quantity |
| | | database with an ingredient of the ingredient |
| | | characteristic database. |
| Quan- | Numer- | The amount of the ingredient required for the recipe. |
| tity | ical | |
| Unit | Text | The unit of measure accompanying the quantity. |

### Ingredient Characteristic Database:

| | Field | |
|---|---|---|
| Field | Type | Description |
| Ingredient | Numer- | The identifier for each ingredient; used |
| ID | ical | to link an ingredient identifier of the |
| | | ingredient quantity database with an ingredient |
| | | of the ingredient characteristic database. |
| Name | Text | Name of the ingredient |
| Description | Text | Description of the ingredient |
| Calories | Text | The amount of calories present in the |
| | | ingredient. |
| Attribute | Text | A list of one or more characteristics of the |
| | | ingredient. |
| Substitute | Numer- | A list of one or more Ingredient IDs |
| Ingredients | ical | corresponding to ingredients that may be |
| | | used as a substitute to the ingredient. |
| Typical | Text | A unit of measure (for example, grams, |
| ingredient | | milliliters etc) typically used to measure |
| package | | the ingredient. |
| unit | | |
| Typical | Numer- | A quantity of the ingredient that is typically |
| ingredient | ical | sold by supermarkets. Based on the unit of |
| package | | measure defined by the “Typical ingredient |
| cost | | package unit” field |
| Perishable | Bool- | Indicates whether or not the ingredient is |
| parameter | ean | quick to perish |
| Associated | Numer- | An identifier used to indicate the category of |
| foreign | ical | the ingredient (for example, vegetable, spice etc). |
| ID | | |

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-34. (canceled)

35. A system for generating a meal plan for one or more persons, the system comprising:
an input device adapted to receive a plurality of input parameters;
a meal map generator adapted to receive at least one of the input parameters received by the input device, and to generate a meal map comprising a plurality of sets of meal parameters based on the at least one of the input parameters, each set of meal parameters comprising one or more meal parameters;
a recipe locator adapted to receive the plurality of sets of meal parameters, to locate a plurality of recipes stored in a recipe database based on the sets of meal parameters, and to retrieve a plurality of recipe identifiers corresponding to the respective located recipes;
an ingredient locator adapted to receive the recipe identifiers, to locate a plurality of sets of ingredients stored in an ingredient database based on the recipe identifiers, and to retrieve a plurality of sets of ingredient quantities corresponding to the respective located sets of ingredients;
an ingredient quantity calculator adapted to receive the sets of ingredient quantities and at least one of the input parameters, and to calculate a plurality of sets of meal ingredient quantities based on the sets of ingredient quantities and the at least one of the input parameters;
a meal plan generator adapted to receive at least one of the group consisting of: the recipe identifiers, the sets of ingredients and the sets of meal ingredient quantities, and to generate a meal plan based on the at least one of the group so received; and
an output device adapted to output the meal plan.

36. The system as claimed in claim 35, wherein each recipe is associated with a portion size parameter indicative of the portion size of a dish prepared according to the recipe, a recipe serve parameter indicative of the number of person or persons a dish prepared according to the recipe is intended to serve, or both a portion size parameter indicative of the portion size of a dish prepared according to the recipe and a recipe serve parameter indicative of the number of person or persons a dish prepared according to the recipe is intended to serve.

37. The system as claimed in claim 35, wherein the input parameters comprises a portion size parameter and a household size parameter indicative of the number of person or persons of a household.

38. The system as claimed in claim 37, wherein the ingredient quantity calculator is further adapted to:
receive the recipe serve parameter corresponding to each one of the recipes, the portion size parameter corresponding to each one of the recipes, the household size parameter, and the portion size parameter of the at least one of the input parameters; and
calculate each one of a set of meal ingredient quantities by (i) dividing a ingredient quantity corresponding to the meal ingredient quantity with the recipe serve parameter corresponding to a recipe and a value comprising or derived from the portion size parameter corresponding to the recipe, and (ii) multiplying the result with the household size parameter and a value comprising or derived from the portion size parameter of the at least one of the input parameters.

39. The system as claimed in claim 35, wherein each of the recipes located by the recipe locator is associated with recipe parameters that match a respective set of meal parameters.

40. The system as claimed in claim 35, comprising a storage device comprising the recipe database and the ingredient database.

41. The system as claimed in claim 35, comprising:
at least one user terminal comprising the input device and the output device; and
a server in data communication with the at least one user terminal, the recipe database, and the ingredient database, the server comprising the meal map generator, the recipe locator, the ingredient locator, the ingredient quantity calculator and the meal plan generator.

42. The system as claimed in claim 35, comprising:
at least one user terminal comprising the input device, the meal map generator, the recipe locator, the ingredient locator, the ingredient quantity calculator, the meal plan generator, and the output device; and
a server in data communication with the at least one user terminal, the recipe database, and the ingredient database.

43. The system as claimed in claim 35, wherein each set of meal parameters comprises at least one meal parameter, each set of ingredients comprises at least one ingredient, each set of ingredient quantities comprises at least one ingredient quantity, and each set of meal ingredient quantities comprises at least one meal ingredient quantity.

44. The system for generating a shopping list comprising a list of corresponding ingredients and ingredient quantities, the system comprising:
a system for generating a meal plan for one or more people, as claimed in claim 35; and
a shopping list generator adapted to receive the sets of ingredients and the sets of meal ingredient quantities, and to generate a shopping list based on the sets of ingredients and the sets of meal ingredient quantities.

45. A method of generating a meal plan for one or more people, the method comprising:
receiving a plurality of input parameters;
generating a meal map comprising a plurality of sets of meal parameters based on at least one of the input parameters;
locating a plurality of recipes stored in a recipe database based on the plurality of sets of meal parameters;
retrieving a plurality of recipe identifiers, each recipe identifier corresponding to a respective one of the plurality of recipes;
locating a plurality of sets of ingredients stored in an ingredient database based on the plurality of recipe identifiers;
retrieving a plurality of sets of ingredient quantities, each ingredient quantity of each set of ingredient quantities corresponding to a respective ingredient of a respective set of ingredients;
calculating a plurality of sets of meal ingredient quantities based on at least one of the input parameters and the plurality of sets of ingredient quantities;
generating a meal plan based on at least one of the group consisting of: the plurality of recipe identifiers, the plurality of sets of ingredients, and the plurality of sets of meal ingredient quantities; and
outputting the meal plan.

46. The method as claimed in claim 45, wherein each recipe is associated with a portion size parameter indicative of the portion size of a dish prepared according to the recipe,
a recipe serve parameter indicative of the number of person or persons a dish prepared according to the recipe is intended to serve, or both a portion size parameter indicative of the portion size of a dish prepared according to the recipe and a recipe serve parameter indicative of the number of person or persons a dish prepared according to the recipe is intended to serve.

47. The method as claimed in claim 45, wherein the input parameters comprises a portion size parameter and a household size parameter indicative of the number of person or persons of a household.

48. The method as claimed in claim 47, wherein each one of the meal ingredient quantities is calculated by (i) dividing an ingredient quantity corresponding to the meal ingredient quantity with the recipe serve parameter corresponding to a recipe and a value comprising or derived from the portion size parameter corresponding to the recipe, and (ii) multiplying the result with the household size parameter and a value comprising or derived from the portion size parameter of the at least one of the input parameters.

49. The method as claimed in claim 45, wherein each of the recipes corresponds to a set of meal parameters, and each of the located recipes is associated with recipe parameters that match a respective set of meal parameters.

50. The method as claimed in claim 45, wherein the recipe database and the ingredient database are stored in the same storage device.

51. The method as claimed in claim 45, wherein the input parameters are received by an input device of a user terminal and the meal plan is outputted by a output device of the user terminal, and wherein the meal map is generated by a meal map generator implemented by a server connected to the recipe database and the ingredient set database, the recipes are located by a recipe locator implemented by the server, the sets of ingredients are located by an ingredient locator implemented by the server, and the sets of meal ingredient quantities are determined by an ingredient quantity calculator implemented by the server.

52. The method as claimed in claim 45, wherein the input parameters are received by an input device of a user terminal in data communication with the recipe database and the ingredient database, the meal plan is outputted by a output device of the user terminal, the meal map is generated by a meal map generator implemented by the user terminal, the recipes are located by a recipe locator implemented by the user terminal, the sets of ingredients are located by an ingredient locator implemented by the user terminal, and the sets of meal ingredient quantities are calculated by an ingredient quantity calculator implemented by the user terminal.

53. The method as claimed in claim 45, wherein each set of meal parameters comprises at least one meal parameter, each set of ingredients comprises at least one ingredient, each set of ingredient quantities comprises at least one ingredient quantity, and each set of meal ingredient quantities comprises at least one meal ingredient quantity.

54. The method for generating a shopping list comprising a list of corresponding ingredients and ingredient quantities, the method comprising:
generating a meal plan for one or more people, as claimed in claim 45; and
generating a shopping list based on the sets of ingredients and the sets of meal ingredient quantities.
